(19) United States
(12) Patent Application Publication
(10) Pub. No.: US 2014/0019515 A1
(43) Pub. Date: Jan. 16, 2014

(54) ADAPTIVE BUSINESS LOGIC CONFIGURATOR

(71) Applicants: Anamitra Bhattacharyya, Chelmsford, MA (US); Sampathkumar Sriramadhesikan, Burlington, MA (US)

(72) Inventors: Anamitra Bhattacharyya, Chelmsford, MA (US); Sampathkumar Sriramadhesikan, Burlington, MA (US)

(73) Assignee: INTERNATIONAL BUSINESS MACHINES CORPORATION, Armonk, NY (US)

(21) Appl. No.: 13/545,188

(22) Filed: Jul. 10, 2012

(51) Int. Cl. G06F 9/44; G06F 15/16

(52) U.S. Cl. 709/203; 717/113

(57) ABSTRACT

A method and server for configuring an application that uses a unit of work which provides functionality for the application includes reading metadata associated with a unit of work; and determining a number of configuration options for the unit of work based on the metadata associated with that unit of work.

### BACKGROUND

When a packaged business application is implemented for a particular system or enterprise, there may be some desired reconfiguration or customization of the application that will allow the application to better suit the needs of that particular deployment. Consequently, packaged business applications are often customized or reconfigured with targeted pieces of code or business logic to better meet end user needs and business requirements.

This customization approach is generally performed by someone having significant expertise with the business application, such as a representative of the application's vendor. This customization approach does not support an adaptive model where an administrator or end user can readily reconfigure existing customizations or other aspects of the business application to suite changes in the business application's deployment or usage.

### SUMMARY

A method and server for configuring an application that uses a unit of work which provides functionality for the application includes reading metadata associated with a unit of work; and determining a number of configuration options for the unit of work based on the metadata associated with that unit of work.

An application server for supporting a number of applications includes: a network connection for providing services of the number of applications to a client device over a network; a repository for containing a number of units of work to be used by applications; and an adaptive business logic configurator programmed for reading metadata associated with a unit of work; and determining a number of configuration options for the unit of work based on the metadata associated with the unit of work.

A computer program product includes a computer readable storage medium, the computer readable storage medium comprising computer readable program code embodied therewith to reconfigure an application that uses a unit of work which provides functionality for the application, the computer readable program code including: computer readable program code to read metadata associated with a unit of work; and computer readable program code to determine a number of configuration options for the unit of work based on the metadata associated with the unit of work display.

### BRIEF DESCRIPTION OF THE SEVERAL VIEWS OF THE DRAWINGS

The accompanying drawings illustrate various embodiments of the principles describe herein and are a part of the specification. The illustrated embodiments are merely examples and do not limit the scope of the claims.

FIG. 1 is a drawing showing an illustrative business application tied to two units of work, according to one example of principles described herein.

FIG. 2 is a drawing showing an illustrative concept of using Adaptive Business Logic Configurator to allow unit of work to be reconfigured as specified by administrator or application manager, according to one example of principles described herein.

FIG. 3 is a flowchart showing an illustrative method for selecting unit of work and deploying unit of work using Adaptive Business Logic Configurator, according to one example described herein.

FIG. 4 is a drawing showing an illustrative mobile device checking validation, according to one example of principles described herein.

### DETAILED DESCRIPTION

As noted above, packaged business applications are often customized or reconfigured with targeted pieces of code or business logic to better meet end user needs and business requirements. This customization is generally performed by someone having significant expertise with the business application, such as a representative of the application's vendor. This customization approach does not support an adaptive model where an administrator or end user can readily reconfigure existing customizations or other aspects of the business application to suite changes in the business application's deployment or usage.

For example, assume a web-based application that is accessed via a browser. This application has data fields into which a user will enter data that the application can validate before proceeding. Assume further that this validation typically involves the transmission of the data from a client device to the server hosting the application. The server validates the data and returns a response, accepting or invalidating the data, to the client device.

Now assume that, as the application evolves, a mobile version is implemented for use by mobile devices, such as smart phones. Such mobile devices may occasionally operate in an off-line mode when network access is unavailable. In such a case, validation of entered data does not occur because the data cannot be sent to the server for validation.

Consequently, it is desired to move the validation function from the server to the mobile device itself so that the application can be more fully utilized in an off-line situation. This, however, will likely be a significant modification to operation of the application that cannot be achieved by the application's administrator or operator.

The subject matter disclosed in the present specification provides such an application administrator or operator the ability to dynamically make such reconfigurations of a business application to suit evolving runtime needs without requiring the expertise to rewrite portions of the application. The present specification discloses methods and systems for continuous adaptation of existing business logic. Consequently, business logic can be reconfigured and deployed over the course of time to suit the particular run-time environment and needs of the end user.

In various examples, an Adaptive Business Logic Configurator (ABLC) is described for use by an administrator or application manager to create or select a unit of work, and then choose from among a set of potential deployment models for that particular unit of work. Newly deployed or reconfigured units of work can then change the operation of the corresponding business application to better suit particular run-time needs.

Throughout this specification and in the appended claims, the term “entity” is to be broadly interpreted as a person, a group of people, or an organization.

Throughout this specification and in the appended claims, the term “unit of work” refers broadly to a predefined function that will be performed on given inputs to produce a desired output. A logical object may embody and be used to perform a specific unit of work. Consequently, a unit of work may encapsulate business logic, computations, and rules that drive business application functionality and use. A unit of work may be authored using any number of program constructs or “rules” tools.

The subject matter described herein can be applied in a variety of different ways. For example, the present specification describes a method for meeting end user needs by allowing an administrator or applications manager to reconfigure existing customizations of packaged business applications. Using an Adaptive Business Logic Configurator (ABLC), the administrator or applications manager creates or selects a unit of work from a library of such units. Once the unit of work is selected, the administrator or applications manager then selects from among a set of potential deployment models for that unit of work. This may include selecting among offered options to configure the unit of work. The unit of work is then dynamically deployed to change or reconfigure the operation of the business application.

In another example, the present specification describes a computerized Adaptive Business Logic Configurator system includes a processor and a memory communicatively coupled to the processor. The processor is configured to allow administer or application manager to create or select a unit of work from available library. After unit of work is created or selected administer or application manager dynamically deploys and delivers unit of work in a particular run-time environment to suit the needs of particular computer platform or mobile device.

In another example, the present specification describes a computer program product for continuous adaptation of existing business logic, the computer program product includes a computer readable storage medium having computer readable codes embodied therewith, the computer readable program codes include computer readable program codes configured to recognize a constraint for a unit of work selected; and computer readable program code configured to deploy and deliver that unit of work in a completely dynamic matter through matching rules to suit particular run-time needs on a computer platform, including a mobile device.

Thus, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combing software and hardware aspects that may all generally be referred to herein as a “circuit,” “module” or “system.” Furthermore, aspects of the present invention my take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable medium may be, for example, but not limited to, an electronic, magnetic, optical electromagnetic, infrared, or semiconductor system, apparatus, or device or any suitable combination of the foregoing. More specific examples (a non-exhaustive list) of the computer readable mediums would include the following: an electrical connection having one or more wires, a portable computer diskette, a hard disk, a random access memory (RAM), a read-only memory (ROM), an erasable programmable read-only memory (EPROP or Flash memory), an optical fiber, a portable compact disk read-only memory (CD-ROM), an optical storage device, a magnetic storage device, or any suitable combination of the foregoing. In the context of this document, a computer readable storage medium may be any tangible medium that can contain, or storage a program for use by or in connection with any instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, thought the internet using an internet service provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via a processor of the computer or other programmable data processing apparatus, create means for implementing the functions/acts specified in the flowchart and/or block diagram block or blocks

These computer program instructions may also be stored in a computer-readable memory that can direct a computer or other programmable data processing apparatus to function in a particular manner, such that the instructions stored in the computer-readable memory produce an article of manufacture including instructions means which implement the functions/act specified in the flowchart and/or block diagram blocks or blocks.

The computer program instructions may also be loaded onto a computer or other programmable data processing apparatus to cause a series of operational steps to be performed on the computer or other programmable apparatus to produce a computer implement process such that the instructions which execute on the computer or other programmable apparatus provide steps for implementing the functions/acts specified in the flowchart and/or block diagram blocks or blocks.

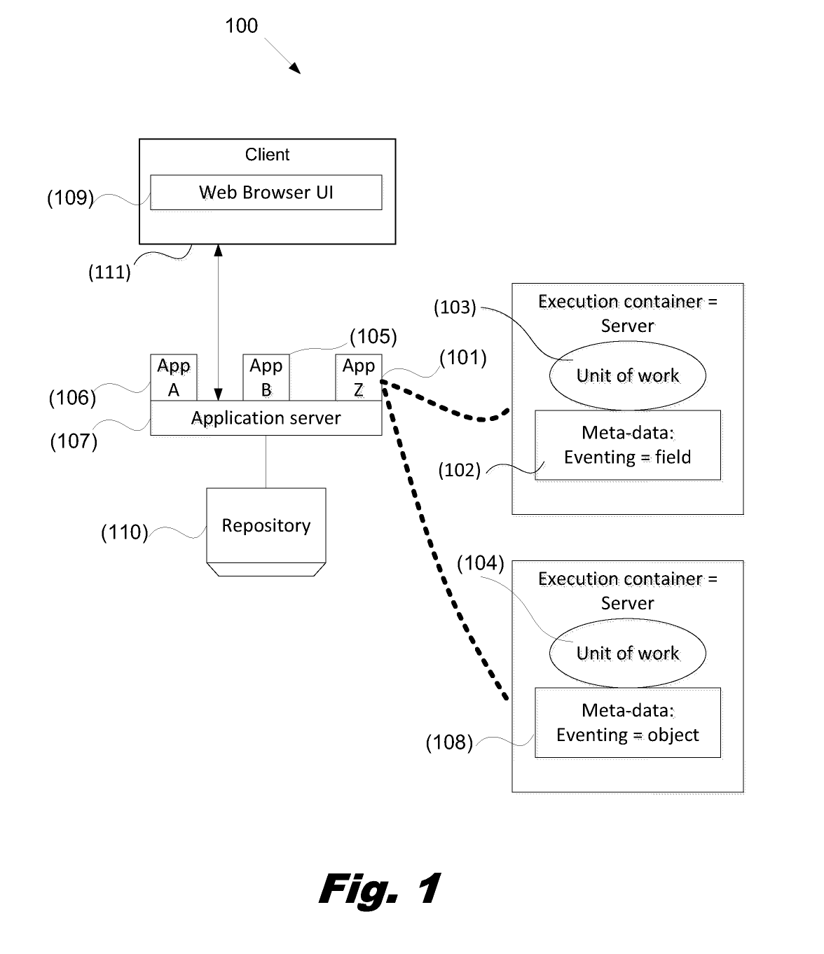

Referring now to the figures, FIG. 1 illustrates the use of units of work, as described herein, to reconfigure the operation of a business application. In FIG. 1, a system (100) is illustrated that includes a number of applications that are accessed over a network, such as the World Wide Web. These applications can be accessed using a web browser (109) as the user interface for any of the applications.

The applications, A (106), B (105) and Z (101), are hosted by an application server (107). The server (107) is connected to the network or web so as to server application data to the browser (109).

In the example of FIG. 1, one of the applications, Z (101), is associated with two units of work (103 and 104). This association is indicated by the two lines in FIG. 1 that connect Applications Z (101) with the two units of work (103 and 104).

One of these units of work (103) executes business logic attached to a single field, as indicated by metadata (102) associated with that unit of work (103). The other unit of work (104) executes record logic attached to a business object, as indicated by metadata (108) associated with that unit of work (104).

These units of work (103, 104) may be part of a library of any number of defined units of work. This library of units of work can be stored in a repository (110) that is accessible to the application server (107). As will be described in further detail below, this library of units of work can be accessed by a system administrator to dynamically reconfigure one or more of the applications supported by the server (107).

In keeping with the example given above of shifting a validation function from a server to a client, suppose that a system administrator determines that the unit of work (103) which executed on a particular data field would be more effective in run in the web browser (109) of a client system (111) rather than on the application server (107). As indicated in FIG. 1, the original execution container for the unit of work (103) is the server.

Suppose further that the system administrator also determines that the other unit of work (104) executing on a particular object can also be used advantageously by another of the applications, for example, B (105). Thus, several these reconfigurations to the system (100) are desired.

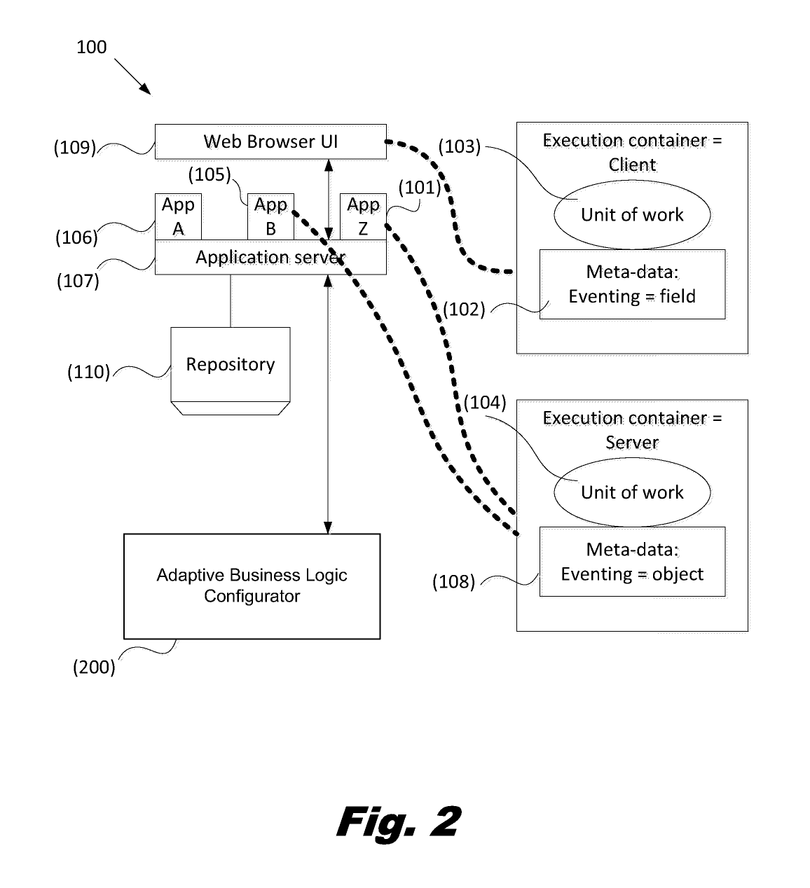

FIG. 2 illustrates the system (100) of FIG. 1 after a reconfiguration according to the changed noted above that are desired by the system administrator or user. As shown in FIG. 2, the object-level unit of work (104) is now associated with both Application Z (101) and Application B (105). Thus, this unit of work (104) is now a common or shared unit of work.

In FIG. 2, the field-level unit of work (103) that was previously associated with Application Z (101) is, instead, assigned to the browser (109). Specifically, the field-level unit of work (103) is cloned or assigned to a client-side execution container as indicated in FIG. 2. Thus, the administrator or application manager can transfer a unit of work from the server side to the client side or vice-versa.

Additionally, the object-level unit of work (104) is now associated with both Applications B (105) and Z (101). Thus, Application B (105) is reconfigured to include the functionality represented by the object-level unit of work (104). This reconfiguration is performed with an Adaptive Business Logic Configurator (200). This Adaptive Business Logic Configurator (200) may reside on the application server (107) or may reside on another system in communication with the application server (107). The operation of the Adaptive Business Logic Configurator (200) will be described below.

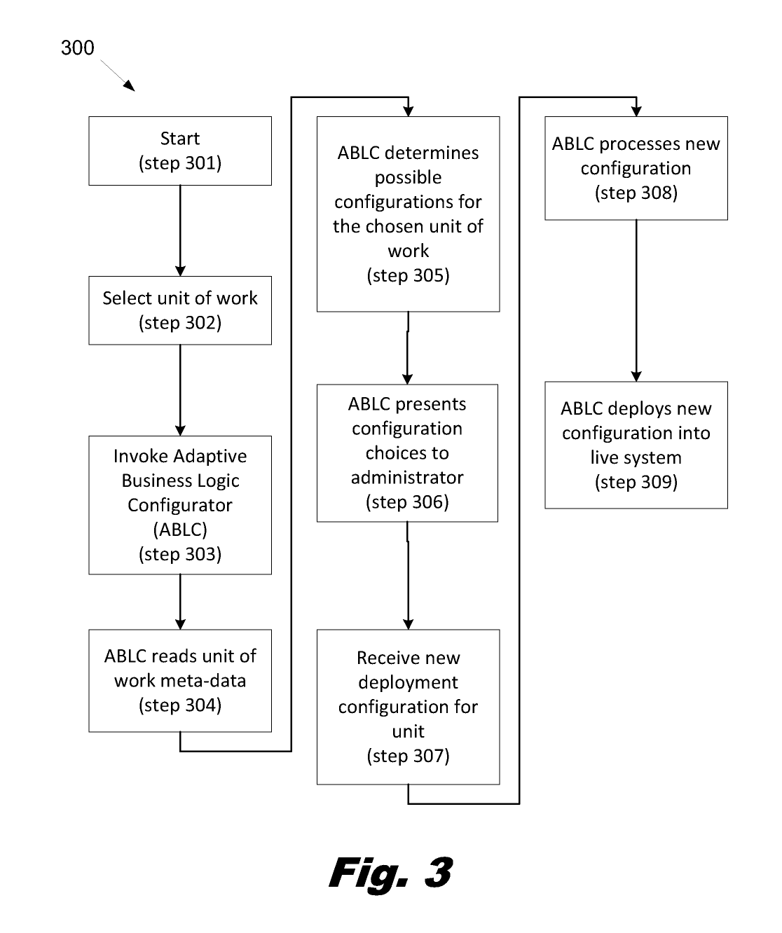

FIG. 3 is a flowchart operation of the Adaptive Business Logic Configurator (200, FIG. 2). The Adaptive Business Logic Configurator may be a software application or may, alternatively, be implemented in firmware, hardware or any combination of the three.

After beginning the reconfiguration process (301), the system administrator will be operating on a selected (302) unit of work. In some examples, the system administrator will use the Adaptive Business Logic Configurator to select (302) a unit of work from an available library of units. As noted above, this library of units of work may be stored in a repository accessible to the application server. Alternatively, the Adaptive Business Logic Configurator may be used to create unit of work rather than merely selecting an existing unit of work. In other examples, the system administrator may first select the unit of work desired and then invoke (303) the Adaptive Business Logic Configurator to operate on the selected unit.

The Adaptive Business Logic Configurator then reads (304) metadata associated with the selected unit of work. This metadata characterizes the unit of work and may include, but is not limited to: input and output parameters, associated business object or objects, associated business application or applications, type of construct used to author the unit of work (language name or rules system), eventing that launches the unit of work, and execution containers that can execute this unit of work based on the eventing.

From this metadata, the Adaptive Business Logic Configurator determines (304) the possible configurations for the desired unit of work. For example, if the metadata indicates that the unit of work in question can be implemented on either the server-side or the client-side, the Adaptive Business Logic Configurator will allow the system administrator to select were that unit of work will be implemented. Alternatively, if the metadata for the unit of work indicates that the unit of work can be shared by multiple applications, the Adaptive Business Logic Configurator will allow the system administrator to associate that unit of work with more than on application.

Specifically, the Adaptive Business Logic Configurator may apply a series of matching rules to the metadata to determine what configuration options are associated with the unit of work. Two illustrative matching rules follow.

Matching rule 1: if the unit of work is associated with a field and is authored in a language that is supported in a web browser or a mobile device native application model, then the unit of work can potentially execute directly on the client tier. This choice can then be provided to administrator or application manager.

Matching rule 2: if the unit of work is attached to a business object or application rather than an application's individual field the rule will identify related business objects or applications that could share the same unit of work. Process the input and output parameters of this unit of work and determine which related business objects can provide or accept the same. List of related business objects can then be provided to the administrator or application manager.

Additionally, the matching rules may provide the administrator or application manager with configurations necessary to deliver and deploy a unit of work to a specific computer platform or mobile device in order to meet specific run-time needs. This will help avoid mismatched run-time environments.

After determining the possible configuration options, the Adaptive Business Logic Configurator presents (306) configurations choices to the administrator or application manager. The administrator or application manager then selects from among these options to configure how the unit of work will be implemented in the existing system and, consequently, reconfiguring the applications that use or will use that unit of work accordingly.

These user selections are referred to as a new deployment configuration. This new deployment configuration is received (307) by the system as specified by the user. The Adaptive Business Logic Configurator then processes (308) the new configuration and then deploys (309) the new configuration. This deployment will be suited to the particular run-time environment for the particular business application and may be performed dynamically in a live or running system.

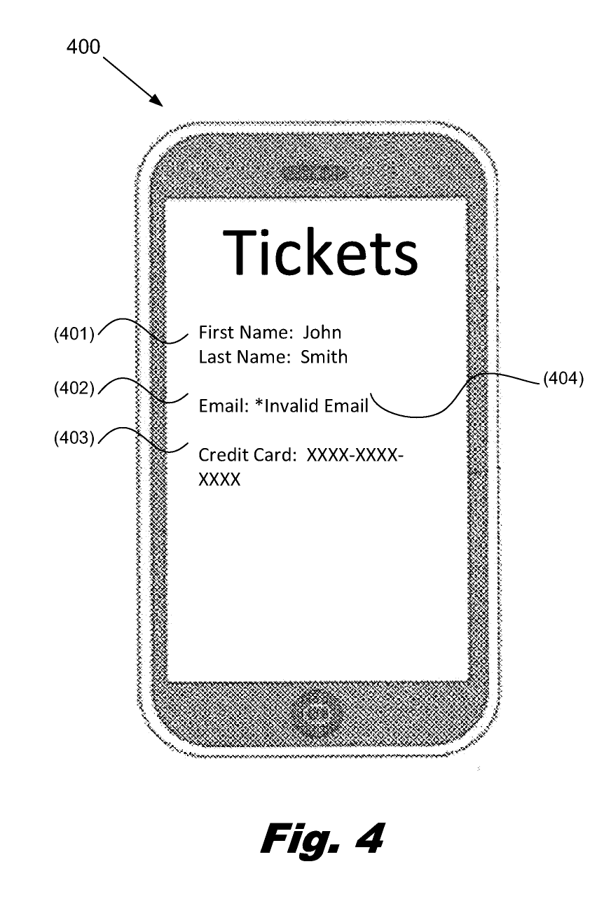

FIG. 4 is a drawing showing an illustrative mobile device (400) that is operating with a system recently reconfigured according to one of the examples used herein. FIG. 4 builds on the example considered herein of moving a validation function from an application server to the client device.

In the example of FIG. 4, the user is using the mobile device (400) to purchase tickets. Consequently, the user enters data, which may include, for example, name (401), email (402), and credit card number (403).

It may be desirable to validate the credit card number before any data is sent to the application server. As in the example above, this functionality may have originally resided on the application server, but is preferred to occur on the mobile device itself to minimize network communications.

Consequently, a unit of work comprising such field validation logic has been moved over to the client, the mobile device (400) using the Adaptive Business Logic Configurator, as described herein. Therefore, the credit card number may be validated by, for example, checking the number of digits or digit pattern, before proceeding. This validation is performed by a unit of work transferred to the mobile device (400). If the entered data does not pass the validation check, the user receives an error message (404), telling the user the information is invalid. Thus, no unnecessary communication occurred between the client device and the supporting application server.

The flowchart and block diagrams in the Figures illustrate the architecture, functionality, and operations of possible implementations of systems, methods and computer program products according to various embodiments of the present invention. In this regard, each block in the flowchart or block diagrams may represent a module, segment, or portion of code, which comprises one or more executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicated otherwise. It will be further understood that the terms “comprises” and/or “comprising” when used in the specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are indicated to include any structure, material, or act for performing the function in combination with other claimed elements as specifically claimed. The description of the present invention has be presented for purpose of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for configuring an application that uses a unit of work which provides functionality for the application, the method comprising:
reading metadata associated with a unit of work; and
determining a number of configuration options for the unit of work based on the metadata associated with said unit of work.

2. The method of claim 1, further comprising:
presenting said configuration options for the unit of work to a user;
receiving selections from among said configuration options from the user; and
configuring said application to use said unit of work in accordance with the selections by the user from among said configuration options.

3. The method of claim 1, further comprising:
receiving user input selecting a unit of work from a library of units of work; and
retrieving metadata associated with that unit of work from said library prior to reading said metadata to determine configuration options for that unit of work.

4. The method of claim 1, wherein determining a number of configuration options for the unit of work based on the metadata associated with said unit of work further comprises applying a number of matching rules to said metadata.

5. The method of claim 1, wherein determining a number of configuration options for the unit of work based on the metadata associated with said unit of work further comprises:
determining input or output parameters of the unit of work; and
determining related business objects that provide or accept those parameters.

6. The method of claim 5, further comprising providing a list of said related business objects to a user.

7. The method of claim 1, wherein said metadata specifies whether said unit of work can be implemented on a server-side only, a client-side only or either a server-side or client-side.

8. The method of claim 7, further comprising, in response to user input selecting a client-side option for said unit of work, configuring a client-side application to use that unit of work accordingly.

9. An application server for supporting a number of applications, said server comprising:
a network connection for providing services of said number of applications to a client device over a network;
a repository for containing a number of units of work to be used by applications; and
an adaptive business logic configurator programmed for
reading metadata associated with a unit of work; and
determining a number of configuration options for the unit of work based on the metadata associated with said unit of work.

10. The application server of claim 9, wherein said adaptive business logic configurator is further programmed for:
presenting said configuration options for the unit of work to a user;
receiving selections from among said configuration options from the user; and
configuring a corresponding application to use said unit of work in accordance with the selections by the user from among said configuration options.

11. The application server of claim 9, wherein said adaptive business logic configurator is further programmed for:
receiving user input selecting a unit of work from a library of units of work stored in said repository; and
retrieving metadata associated with that unit of work from said library prior to reading said metadata to determine configuration options for that unit of work.

12. The application server of claim 9, wherein determining a number of configuration options for the unit of work based on the metadata associated with said unit of work further comprises applying a number of matching rules to said metadata.

13. The application server of claim 9, wherein determining a number of configuration options for the unit of work based on the metadata associated with said unit of work further comprises:
determining input or output parameters of the unit of work; and
determining related business objects that provide or accept those parameters.

14. The application server of claim 13, wherein said adaptive business logic configurator is further programmed for providing a list of said related business objects to a user.

15. The application server of claim 9, wherein said metadata specifies whether said unit of work can be implemented on a server-side only, a client-side only or either a server-side or client-side.

16. The application server of claim 15, wherein said adaptive business logic configurator is further programmed for, in response to user input selecting a client-side option for said unit of work, configuring a client-side application to use that unit of work accordingly.

17. A computer program product, comprising:
a computer readable storage medium, said computer readable storage medium comprising computer readable program code embodied therewith to reconfigure an application that uses a unit of work which provides functionality for the application, said computer readable program code comprising:
computer readable program code to read metadata associated with a unit of work; and
computer readable program code to determine a number of configuration options for the unit of work based on the metadata associated with said unit of work display.

18. The computer program product of claim 17, further comprising:
computer readable program code to present said configuration options for the unit of work to a user;
computer readable program code to receive selections from among said configuration options from the user; and
computer readable program code to reconfigure said application to use said unit of work in accordance with the selections by the user from among said configuration options.

19. The computer program product of claim 17, further comprising:
computer readable program code to receive user input selecting a unit of work from a library of units of work; and
computer readable program code to retrieve metadata associated with that unit of work from said library prior to reading said metadata to determine configuration options for that unit of work.

20. The computer program product of claim 17, further comprising, wherein determining a number of configuration options for the unit of work based on the metadata associated with said unit of work further comprises:
determining input or output parameters of the unit of work; and
determining related business objects that provide or accept those parameters.
